(19) United States
(12) Patent Application Publication
(10) Pub. No.: US 2024/0181648 A1
(43) Pub. Date: Jun. 6, 2024

(54) WELDING PATH GENERATING SYSTEM AND WELDING PATH GENERATING METHOD

(71) Applicant: Metal Industries Research & Development Centre, Kaohsiung (TW)

(72) Inventors: Ching-Shun Liang, Kaohsiung City (TW); Yu-Zheng Jiang, Kaohsiung City (TW); Cheng-Chang Chiu, Pingtung County (TW)

(73) Assignee: Metal Industries Research & Development Centre, Kaohsiung (TW)

(21) Appl. No.: 18/076,306

(22) Filed: Dec. 6, 2022

(51) Int. Cl. B25J 9/16; B23K 37/02; B25J 11/00; B25J 13/08; G06T 7/11; G06T 7/70

(52) U.S. Cl. CPC B25J 9/1697; B23K 37/0229; B25J 9/1664; B25J 11/005; B25J 13/08; G06T 7/11; G06T 7/70; G05B 2219/32335; G05B 2219/45104; G06T 2207/10028; G06T 2207/20021; G06T 2207/20081; G06T 2207/20084

(57) ABSTRACT

A welding path generating system and a welding path generating method are provided. The welding path generating system includes an image sensor, a storage device, and a processor. The image sensor obtains a sensing image of a welding target. The storage device stores a vision analysis module, an analysis module, and a path planning module. The processor is coupled to the storage device and the image sensor. The processor executes the vision analysis module to analyze the sensing image and create scan data. The processor executes the analysis module to identify weld bead profile information according to the scan data. The processor executes the path planning module to generate welding path information according to the weld bead profile information.

### BACKGROUND

### Technical Field

The disclosure relates to a path estimation technology. In particular, the disclosure relates to a welding path generating system and a welding path generating method.

### Description of Related Art

At present, a welding operation between one plate material and another is performed by a user manually operating welding equipment, and thus lacks efficiency. In particular, when the plate material to be welded is a thick plate, and multi-layer welding is required to weld two plate materials, the welding operation may be complicated. In addition, welding failure or machine collision is likely to occur as human error, or failure to attend to a welding procedure specification and golden welding samples, is likely to occur.

### SUMMARY

The disclosure provides a welding path generating system and a welding path generating method, in which a welding path may be automatically generated for convenient automated welding operations.

According to an embodiment of the disclosure, a welding path generating system includes an image sensor, a storage device, and a processor. The image sensor is configured to obtain a sensing image of a welding target. The storage device is configured to store a vision analysis module, an analysis module, and a path planning module. The processor is coupled to the storage device and the image sensor. The processor executes the vision analysis module to analyze the sensing image and create scan data. The processor executes the analysis module to identify weld bead profile information according to the scan data. The processor executes the path planning module to generate welding path information according to the weld bead profile information.

According to an embodiment of the disclosure, a welding path generating method includes the following. A sensing image of a welding target is obtained by an image sensor. The sensing image is analyzed and scan data is created by a processor. Weld bead profile information is identified by the processor according to the scan data. Welding path information is generated by the processor according to the weld bead profile information.

Based on the foregoing, in the welding path generating system and the welding path generating method according to the embodiments of the disclosure, the weld bead profile may be identified through image scanning, and the welding path information may be generated according to the weld bead profile information.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a welding path generating system according to an embodiment of the disclosure.

FIG. 2 is a schematic diagram of a plurality of modules according to an embodiment of the disclosure.

FIG. 3 is a flowchart of a welding path generating method according to an embodiment of the disclosure.

FIG. 4 is a schematic diagram of a welding scenario according to an embodiment of the disclosure.

FIG. 5 is a schematic diagram of scan data according to an embodiment of the disclosure.

FIG. 6 is a flowchart of a welding path generating method according to another embodiment of the disclosure.

FIG. 7 is a side view of a welding result according to another embodiment of the disclosure.

### DESCRIPTION OF THE EMBODIMENTS

In order to make the content of the disclosure may be easier to understand, the following embodiment is specially cited as an example that this disclosure can indeed be implemented. In addition, wherever possible, elements/members/steps using the same reference numerals in the drawings and embodiments represent the same or similar parts.

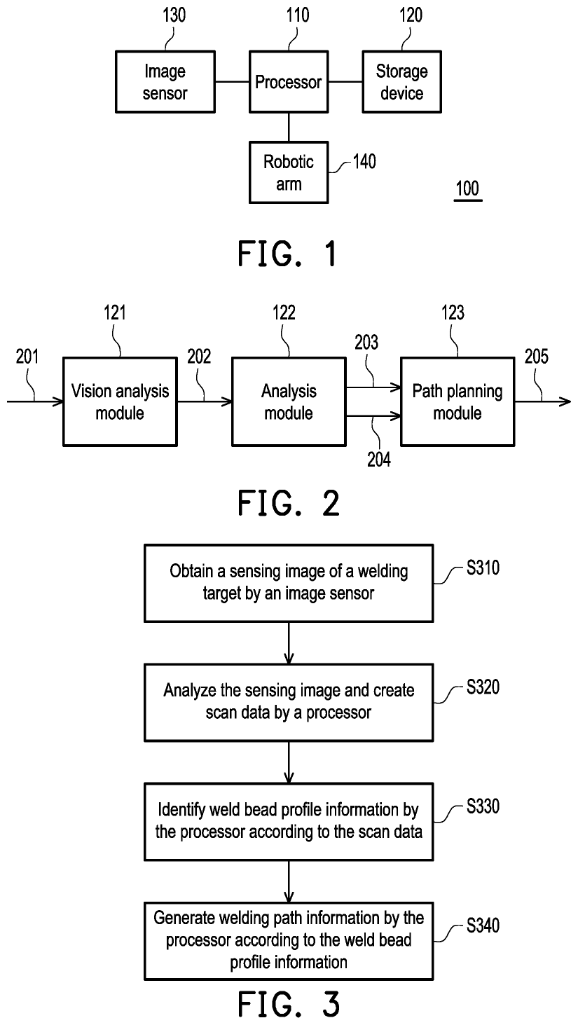

FIG. 1 is a schematic diagram of a welding path generating system according to an embodiment of the disclosure. With reference to FIG. 1, a welding path generating system 100 includes a processor 110, a storage device 120, an image sensor 130, and a robotic arm 140. The processor 110 is coupled to the storage device 120, the image sensor 130, and the robotic arm 140. The robotic arm 140 may be equipped with relevant welding equipment (including heating equipment for welding, for example). In this embodiment, the processor 110 may obtain the current welding scenario through the image sensor 130, and execute relevant modules (i.e., software, programs, algorithms, or the like) stored in the storage device 120 to determine the welding bead outline in the current welding scenario by visual analysis, so that welding path information is generated. The processor 110 may control the robotic arm 140 according to the welding path information to realize automated welding operations.

In this embodiment, the processor 110 may be configured in an electronic device with computing functions, such as a personal computer (PC), a notebook computer, a tablet, an industrial computer, an embedded computer, or a cloud server, but is not so limited by the disclosure. In this embodiment, the storage device 120 may include memory. The memory may be non-volatile memory such as read only memory (ROM) and erasable programmable read only memory (EPROM); volatile memory such as random access memory (RAM); and other memory such as a hard disc drive and semiconductor memory. The storage device 120 is configured to store various modules, images, information, parameters, and data mentioned in the disclosure, which may be read and executed by the processor 110 to realize image analysis, analytical operation, and control functions of the robotic arm 140 to be described in the embodiments of the disclosure.

In this embodiment, the image sensor 130 may be a depth camera or a structured light camera to scan a welding target by emitting three-dimensional structured light, for example. In other words, a sensing image obtained by the processor 110 through the image sensor 130 may be an image having depth information. In this embodiment, the robotic arm 140 may include a plurality of joint axes to realize, for example, a robotic arm with six degrees of freedom in a space, but the disclosure is not limited thereto.

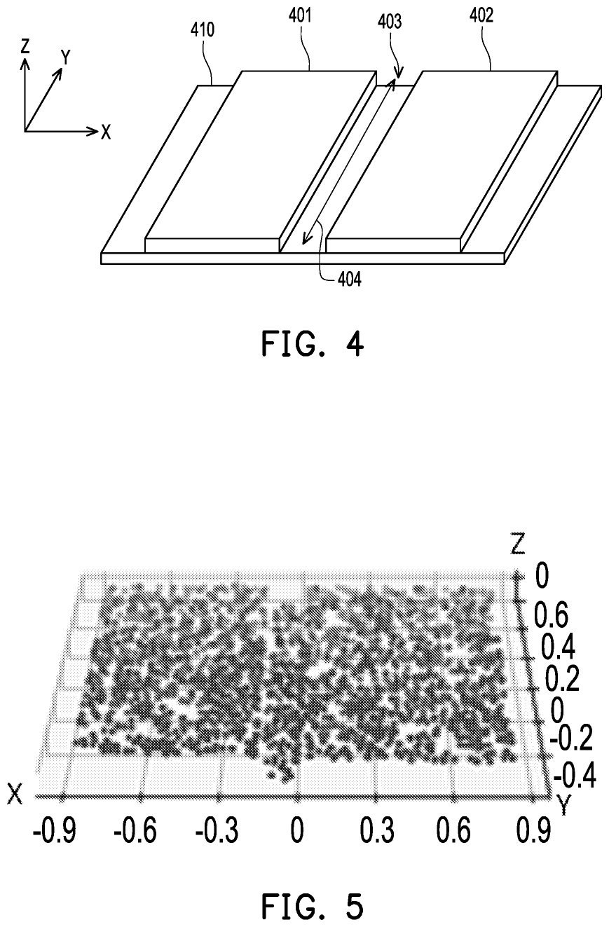

FIG. 2 is a schematic diagram of a plurality of modules according to an embodiment of the disclosure. FIG. 3 is a flowchart of a welding path generating method according to an embodiment of the disclosure. FIG. 4 is a schematic diagram of a welding scenario according to an embodiment of the disclosure. FIG. 5 is a schematic diagram of scan data according to an embodiment of the disclosure. With reference to FIG. 1 to FIG. 5, the storage device 120 may store a vision analysis module 121, an analysis module 122, and a path planning module 123. In this embodiment, the welding path generating system 100 may execute the vision analysis module 121, the analysis module 122, and the path planning module 123 to perform operations as in step S310 to S340 below to realize welding path generation.

In step S310, the processor 110 may obtain a sensing image 201 of a welding target through the image sensor 130. As shown in FIG. 4, a plate material 401 and a plate material 402 may each be a thick plate of a metal material. The plate material 401 and the plate material 402 may first be placed or fixed to a substrate 410, so that the welding path generating system 100 may perform a welding operation on a predetermined welding region 403 between the plate material 401 and the plate material 402, and weld the plate material 401 and the plate material 402 together through a welding material (not shown). The plate material 401 and the plate material 402 may be placed parallel to each other on a plane of the substrate 410 extending in the Y direction and the X direction. In this embodiment, the image sensor 130 may photograph the plate material 401 and the plate material 402, for example, in a direction that include a fixed angle with the Z axis, to obtain the sensing image 201 having depth information.

In step S320, the processor 110 may analyze the sensing image 201 and create scan data 202. In this embodiment, the processor 110 may execute the vision analysis module 121 and input the sensing image 201 to the vision analysis module 121, so that the vision analysis module 121 analyzes the sensing image 201, and create the scan data 202. The scan data 202 may be stereoscopic point cloud data as shown in FIG. 5.

In step S330, the processor 110 may identify weld bead profile information according to the scan data 202. In this embodiment, the analysis module 122 may include a trained deep point cloud analysis network. The deep point cloud analysis network may be a deep convolutional neural network (CNN). The processor 110 may execute the analysis module 122 to perform point cloud feature sampling on the point cloud data, and extract features from deep to shallow. Next, the analysis module 122 may perform weld bead topographical identification to generate a weld bead topographical identification result 203. The weld bead topographical identification result refers to defining the topography corresponding to the plate material 401, the plate material 402, and welding materials for a plurality of point clouds in the point cloud data for classification and determination. The analysis module 122 may also perform weld bead base material segmentation to segment the point cloud data of the regions of the plate material 401, the plate material 402, and the welding materials to generate a weld bead base material segmentation point cloud 204. Accordingly, the analysis module 122 may output the weld bead topographical identification result 203 including the welding target and the weld bead base material segmentation point cloud 204 to the path planning module 123.

In step S340, the processor 110 may generate welding path information according to the weld bead profile information. In this embodiment, the processor 110 may execute the path planning module 123, so that the path planning module 123 may fit the weld bead topographical identification result 203 and the weld bead base material segmentation point cloud 204 according to the point cloud model as shown in FIG. 5 to generate welding path information 205. The welding path information 205 may refer to the position information (including parameters for defining a path, for example, coordinates and vectors) of a welding path 404 of the current welding bead in the welding region 403. Accordingly, the welding path generating system 100 may automatically generate the welding path 404 of the current welding bead by visual analysis.

Moreover, in an embodiment, the storage device 120 may also store a robotic arm operation module. The processor 110 may execute the robotic arm operation module to operate the robotic arm 140 through the robotic arm operation module to perform a welding operation on the welding target according to the welding path information 205. As shown in FIG. 4, the processor 110 may operate the robotic arm 140 along the welding path 404 to perform a welding operation on the welding region 403.

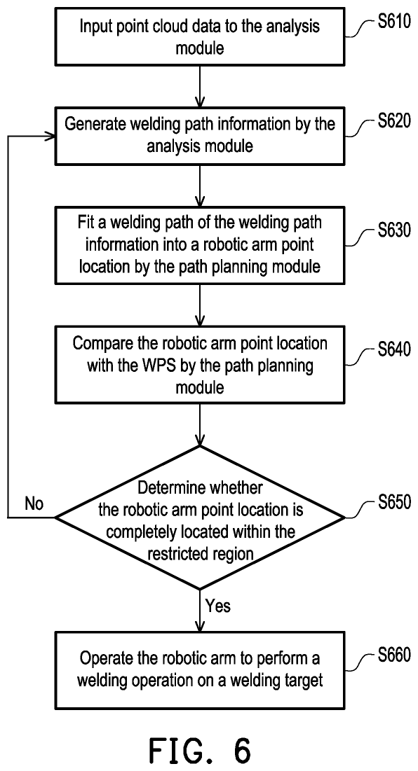

FIG. 6 is a flowchart of a welding path generating method according to another embodiment of the disclosure. With reference to FIG. 1. FIG. 2, FIG. 4, and FIG. 6, the processor 110 may also input a welding procedure specification (WPS) and multi-layer welding data to a deep point cloud analysis network in advance to train the deep point cloud analysis network. As such, the welding path generating system 100 can realize multi-layer welding to effectively weld the plate material 401 and the plate material 402 together through multi-layer welding materials. In addition, to effectively enhance the precision of the path to be welded, the processor 110 may also fine-tune model parameters of the deep point cloud analysis network in advance to verify the deep point cloud analysis network. Furthermore, the processor 110 may also input a plurality of golden welding samples to the deep point cloud analysis network in advance to train the deep point cloud analysis network. The golden welding sample may be, for example, a golden straight welding sample, a golden curved welding sample, and so on, which is not limited by the disclosure. In this regard, the welding path generating system 100 may perform, for example, step S610 to S660 below to realize accurate welding operations.

In step S610, the processor 110 may input point cloud data to the analysis module 122. In step S620, the analysis module 122 may generate welding path information. In step S630, the path planning module 123 may first fit (multi-dimensionally fit) a welding path of the welding path information into a robotic arm point location. The robotic arm point location may refer to a plurality of consecutive location points of feature points or profiles of the distal end of the robotic arm 140 performing welding operations and moving along the welding path 404. In step S640, the path planning module 123 may then compare the robotic arm point location with the WPS. For example, a welding range of a restricted region may be defined in the WPS. In step S650, the processor 110 may determine whether the robotic arm point location is completely located within the restricted region (a three-dimensional spatial region). If it is determined not, the processor 110 may execute the analysis module 122 again to generate new welding path information that is adjusted. If it is determined yes, in step S660, the processor 110 may operate the robotic arm 140 to perform a welding operation on a welding target (perform a welding operation on the welding region 403 along the welding path 404). In other words, according to the welding path information after the safety determination described above, the processor 110 may operate the robotic arm 140 to perform a safe and appropriate welding operation on the welding target, effectively preventing collision of the robotic arm 140 with machines during an automated welding operation (i.e., unexpected collision of the robotic arm 140 with a plate material, a machine board, or a welding material).

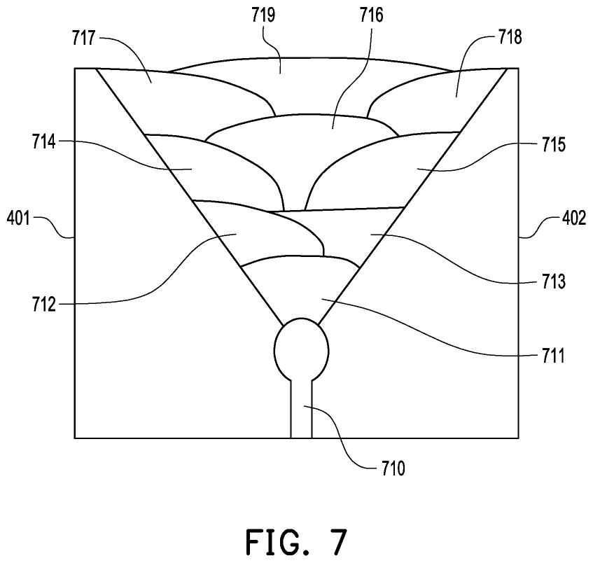

FIG. 7 is a side view of a welding result according to another embodiment of the disclosure. For example, FIG. 7 may be a schematic view corresponding to the Y direction in FIG. 4. With reference to FIG. 1. FIG. 2, and FIG. 7, in this embodiment, after the robotic arm 140 completes a first welding operation on a welding target (i.e., the welding region 403), a first welding material 710 may be formed between the plate material 401 and the plate material 402. Next, the image sensor 130 may obtain the next sensing image of the welding target (i.e., the welding region 403) again. The processor 110 may execute the welding path generating method described above again. The processor 110 may execute the vision analysis module 121 to analyze the next sensing image and create the next scan data. The processor 110 may execute the analysis module 122 to identify the next weld bead profile information according to the next scan data. The processor 110 may execute the path planning module 123 to generate the next welding path information according to the next weld bead profile information. Accordingly, the processor 110 may operate the robotic arm 140 to perform a second welding operation on the welding target (i.e., the welding region 403). After the robotic arm 140 completes the second welding operation on the welding target (i.e., the welding region 403), a second welding material 711 may be formed between the plate material 401 and the plate material 402. By analogy, the processor 110 repeatedly executes the welding path generating method described above, so that a plurality of welding materials 711 to 719 may be formed between the plate material 401 and the plate material 402 through multi-layer welding. Accordingly, the plate material 401 and the plate material 402 may be effectively welded together through the welding materials 711 to 719.

In summary of the foregoing, in the welding path generating system and the welding path generating method according to the embodiments of the disclosure, models may be created through visual analysis and creation of scan data, and the welding path may be automatically generated through the analysis model and path planning to realize automated welding. In the welding path generating system and the welding path generating method of the disclosure, during path planning, the welding path may also be generated based on the WPS and the golden welding sample to achieve safe and reliable welding operations.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A welding path generating system comprising:
an image sensor configured to obtain a sensing image of a welding target;
a storage device configured to store a vision analysis module, an analysis module, and a path planning module; and
a processor coupled to the storage device and the image sensor,
wherein the processor executes the vision analysis module to analyze the sensing image and create scan data,
wherein the processor executes the analysis module to identify weld bead profile information according to the scan data, and
wherein the processor executes the path planning module to generate welding path information according to the weld bead profile information.

2. The welding path generating system according to claim 1, wherein the image sensor is a depth camera or a structured light camera, and the sensing image is an image having depth information.

3. The welding path generating system according to claim 2, wherein the analysis module comprises a deep point cloud analysis network, and the scan data is point cloud data.

4. The welding path generating system according to claim 3, wherein the weld bead profile information comprises a weld bead topographical identification result of the welding target and a weld bead base material segmentation point cloud, and the path planning module fits the weld bead topographical identification result and the weld bead base material segmentation point cloud to generate the welding path information.

5. The welding path generating system according to claim 3, wherein the processor inputs multi-layer welding data to the deep point cloud analysis network in advance to train the deep point cloud analysis network, and the processor fine-tunes model parameters of the deep point cloud analysis network in advance to verify the deep point cloud analysis network.

6. The welding path generating system according to claim 5, wherein the processor further inputs a plurality of golden welding samples to the deep point cloud analysis network in advance to train the deep point cloud analysis network.

7. The welding path generating system according to claim 1, wherein the path planning module fits a welding path of the welding path information into a robotic arm point location, and the path planning module determines whether the robotic arm point location of the welding path information is completely located within a restricted region according to a welding procedure specification,
wherein the processor executes the path planning module to regenerate new welding path information when the robotic arm point location is not completely located within the restricted region.

8. The welding path generating system according to claim 1, wherein the storage device further stores a robotic arm operation module, and
wherein the processor executes the robotic arm operation module to operate a robotic arm through the robotic arm operation module to perform a welding operation on the welding target according to the welding path information.

9. The welding path generating system according to claim 1, wherein the image sensor obtains a next sensing image of the welding target after the robotic arm completes the welding operation on the welding target,
wherein the processor executes the vision analysis module to analyze the next sensing image and create next scan data,
wherein the processor executes the analysis module to identify next weld bead profile information according to the next scan data, and
wherein the processor executes the path planning module to generate next welding path information according to the next weld bead profile information.

10. A welding path generating method comprising:
obtaining a sensing image of a welding target by an image sensor;
analyzing the sensing image and creating scan data by a processor;
identifying weld bead profile information by the processor according to the scan data; and
generating welding path information by the processor according to the weld bead profile information.
